(19) United States
(12) Patent Application Publication
(10) Pub. No.: US 2022/0048766 A1
(43) Pub. Date: Feb. 17, 2022

(54) METHOD AND REACTOR TO PRODUCE SYNGAS

(71) Applicant: SOUTHERN RESEARCH INSTITUTE, Birmingham, AL (US)

(72) Inventor: Mikhail Granovskiy, Fultondale, AL (US)

(21) Appl. No.: 17/399,462

(22) Filed: Aug. 11, 2021

Related U.S. Application Data
(60) Provisional application No. 63/064,461, filed on Aug. 12, 2020.

(51) Int. Cl. C01B 3/36; C01B 3/38; B01J 12/00; B01J 19/00; B01J 19/24

(52) U.S. Cl. CPC C01B 3/363; C01B 3/382; B01J 12/00; B01J 19/0013; B01J 19/242; B01J 2219/00157; C01B 2203/0816; C01B 2203/0255; C01B 2203/0233; C01B 2203/0238; C01B 2203/1241; C01B 2203/0822

(57) ABSTRACT

Disclosed herein is a method and a reactor for the conversion of a hydrocarbon gas to syngas. The method and reactor utilizes a oxy-hydrogen flame to partially oxidize hydrocarbon gas to syngas by provide an excess flow of oxygen gas. The oxy-hydrogen flame is generated by a multi-tubular oxy-hydrogen burner.

### CROSS-REFERENCE TO RELATED APPLICATIONS

This application claims the benefit of Provisional Application No. 63/064,461, filed Aug. 12, 2020, which is hereby incorporated by reference in its entirety.

### FEDERALLY SPONSORED RESEARCH

This invention was made with government support under DE-FE0031531 awarded by U.S. Department of Energy. The government has certain rights in the invention.

### BACKGROUND

Synthesis gas or syngas, which terms can be used interchangeably, is a gas mixture primarily comprising hydrogen gas (H₂) and carbon monoxide gas (CO), along with other potential gases such as nitrogen (N₂), steam (H₂O), and carbon dioxide (CO₂), and possibly various inorganic impurities, such as sulfur and chlorine containing species. Syngas is a feedstock for manufacturing of numerous commercial chemicals as to methanol and ammonia as well as synthetic fuels obtained with Fischer-Tropsch technology.

Syngas can be produced from naturally recovered methane (natural gas) as well as from other carbonaceous species representing intermediate products of various industrial processes, such as gasification and pyrolysis. There are three primary methods to convert feedstock hydrocarbons to syngas: steam reforming, dry reforming, and partial oxidation with oxygen or air. In contrast to air, partial oxidation with oxygen generates a concentrated flow of CO and H₂, not diluted in nitrogen (N₂), which is what happens with air is used. In spite of the necessity to separate air, partial oxidation of hydrocarbons with oxygen is still an attractive option due to its fast reaction kinetics associated with a small and compact reactor and applicability to different hydrocarbons with an possibility not to use a catalyst. Partial oxidation fits the best to small and middle scale syngas production units.

Accordingly, there is a need to improve reactors and methods that can perform the partial oxidation process of a feedstock hydrocarbon gas to produce syngas. Such a method and reactor are disclosed herein.

### SUMMARY

Disclosed herein is a reactor comprising:
a) a multi-tubular oxy-hydrogen burner having a first end and a second end, wherein the first end extends along a longitudinal axis from a first reactor wall, wherein the oxy-hydrogen multi-tubular burner has an outer surface; and
b) a tube made of a high temperature resistant material having a first end and a second end extending along the longitudinal axis, wherein the tube of the high temperature resistant material has an inner surface,
   i. wherein a space is defined between the first end of the tube of the high temperature resistant material and the first reactor wall,
   ii. wherein the tube of the high temperature resistant material surrounds the multi-tubular oxy-hydrogen burner, thereby defining a space between the outer surface of the multi-tubular oxy-hydrogen burner and the inner surface of the tube of the high temperature resistant material,
   iii. wherein the tube of the high temperature resistant material extends past the second end of the multi-tubular oxy-hydrogen burner along the longitudinal axis, and
   iv. wherein a partial oxidation zone is formed from the second end of the multi-tubular oxy-hydrogen burner to the second end of the tube of the high temperature resistant material.

Also disclosed herein is a method of producing syngas comprising the steps of:
a) providing an oxy-hydrogen flame generated by a multi-tubular oxy-hydrogen burner comprising an inner tube and an outer tube by delivering a flow of hydrogen gas through the inner tube and delivering a flow of oxygen gas through the outer tube of the multi-tubular oxy-hydrogen burner, wherein the delivered oxygen gas is provided in excess to the stoichiometric amount to completely burn the delivered hydrogen gas; and
b) directly interacting hydrocarbon gas with the oxy-hydrogen flame by introducing the hydrocarbon gas upstream of the multi-tubular oxy-hydrogen burner to flow in a direction substantially parallel to the oxy-hydrogen flame, wherein the excess of the oxygen gas in the oxy-hydrogen flame partially oxidizes the hydrocarbon gas to produce syngas.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION OF THE FIGURES

These and other features of the preferred embodiments of the invention will become more apparent in the detailed description in which reference is made to the appended drawings wherein:

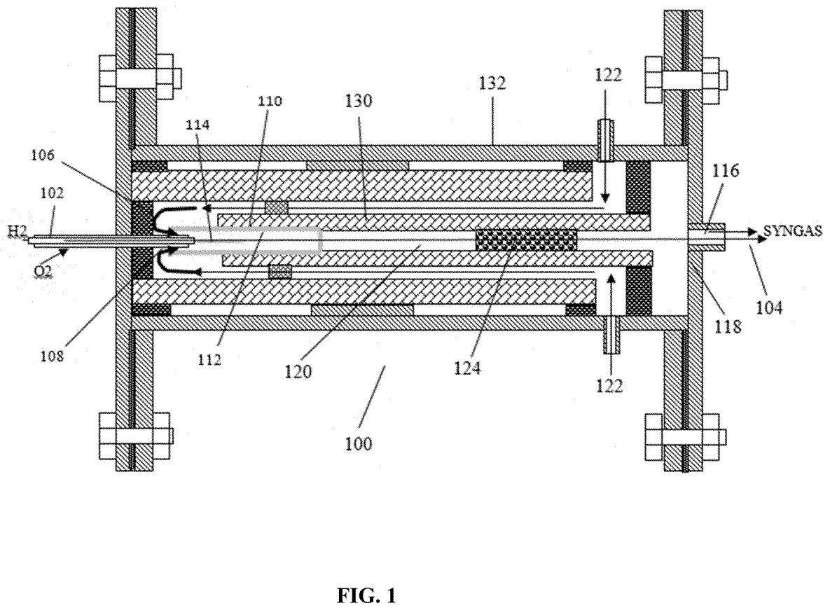

FIG. 1 shows an exemplary reactor disclosed herein.

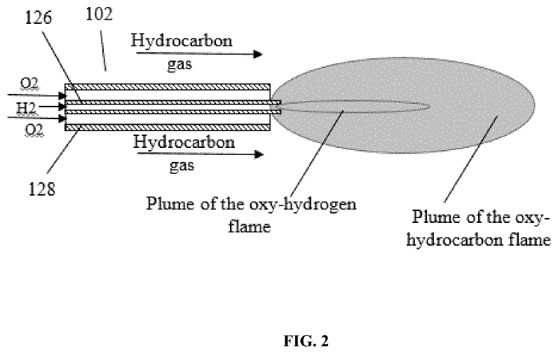

FIG. 2 shows an exemplary multi-tubular oxy-hydrogen burner, which is a part of a reactor disclosed herein.

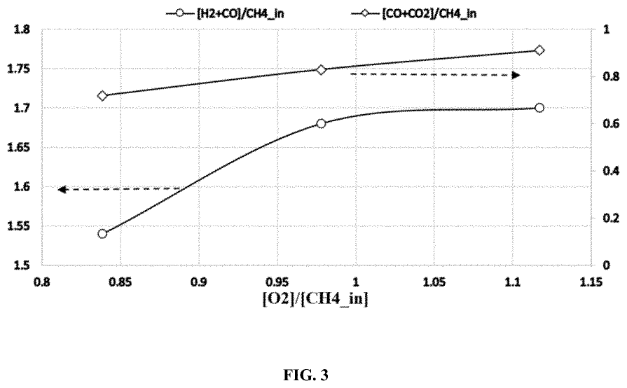

FIG. 3 shows syngas production and methane conversion efficiencies of a method disclosed herein.

### DETAILED DESCRIPTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

It is also to be understood that the terminology used herein is for the purpose of describing particular aspects only and is not intended to be limiting. Although any devices and methods similar or equivalent to those described herein can be used in the practice or testing of the present invention, example methods and materials are now described.

As used in the specification and in the claims, the term “comprising” can include the aspects “consisting of” and “consisting essentially of” Unless defined otherwise, all technical and scientific terms used herein have the same meaning as commonly understood by one of ordinary skill in the art to which this invention belongs. In this specification and in the claims, which follow, reference will be made to a number of terms which shall be defined herein.

As used in the specification and the appended claims, the singular forms “a,” “an” and “the” include plural referents unless the context clearly dictates otherwise. Thus, for example, reference to “a subject” includes two or more subjects.

The terms “first,” “second,” “first reactor wall,” “second reactor wall,” and the like, where used herein, do not denote any order, quantity, or importance, and are used to distinguish one element from another, unless specifically stated otherwise.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

### 1. Reactor and Method

It is known that a hydrocarbon gas, for instance, methane (CH₄) can be converted to syngas by use of catalysts. However, these catalysts are easily deactivated through poisoning and fouling. Sulfur and/or chlorine containing species in the hydrocarbon gas are often the main cause of a catalyst deactivation. The reactor and method disclosed herein can be employed to convert a feedstock hydrocarbon gas to syngas without the need of a catalyst. However, a catalyst can be used in combination with the disclosed method to improve its efficiency. For example, a catalyst can be used if there are no poisonous contaminants or if the catalyst is sufficiently resistant to them. The reactor and method disclosed herein are employed to organize a direct contact of a feedstock hydrocarbon gas and an oxy-hydrogen flame to partially oxidize the hydrocarbon gas into syngas, which is a gas mixture primarily comprising of hydrogen gas and carbon monoxide gas. The reactor ignites and maintains a reaction of a feedstock hydrocarbon gases with a sub-stoichiometric (in respect to hydrocarbon combustion) amount of oxygen leading to their partial oxidation. The oxygen provided can be of an industrial grade oxygen containing, for example, from 90% to 99.9% of O₂ in contrast to air, which contains about 21% of O₂. The reactor is a compact, low-capital investment device generating syngas for the following downstream processing into chemicals and synthetic fuels.

Disclosed herein is a reactor comprising:
c) a multi-tubular oxy-hydrogen burner having a first end and a second end, wherein the first end extends along a longitudinal axis from a first reactor wall, wherein the oxy-hydrogen multi-tubular burner has an outer surface; and
d) a tube made of a high temperature resistant material having a first end and a second end extending along the longitudinal axis, wherein the tube of the high temperature resistant material has an inner surface,
   i. wherein a space is defined between the first end of the tube of the high temperature resistant material and the first reactor wall,
   ii. wherein the tube of the high temperature resistant material surrounds the multi-tubular oxy-hydrogen burner, thereby defining a space between the outer surface of the multi-tubular oxy-hydrogen burner and the inner surface of the tube of the high temperature resistant material,
   iii. wherein the tube of the high temperature resistant material extends past the second end of the multi-tubular oxy-hydrogen burner along the longitudinal axis, and
   iv. wherein a partial oxidation zone is formed from the second end of the multi-tubular oxy-hydrogen burner to the second end of the tube of the high temperature resistant material.

Also disclosed herein is a method of producing syngas comprising the steps of:
a) providing an oxy-hydrogen flame generated by a multi-tubular oxy-hydrogen burner comprising an inner tube and an outer tube by delivering a flow of hydrogen gas through the inner tube and delivering a flow of oxygen gas through the outer tube of the multi-tubular oxy-hydrogen burner, wherein the delivered oxygen gas is provided in excess to the stoichiometric amount to completely burn the delivered hydrogen gas; and
b) directly interacting hydrocarbon gas with the oxy-hydrogen flame by introducing the hydrocarbon gas upstream of the multi-tubular oxy-hydrogen burner to flow in a direction substantially parallel to the oxy-hydrogen flame, wherein the excess of the oxygen gas in the oxy-hydrogen flame partially oxidizes the hydrocarbon gas to produce syngas.

The method disclosed herein can be performed with the reactor disclosed herein.

As described, the reactor and method disclosed herein utilizes a multi-tubular oxy-hydrogen burner that provides for an oxy-hydrogen flame. The a multi-tubular oxy-hydrogen burner comprises an inner tube and an outer tube, and delivers a flow of hydrogen gas through the inner tube and delivering a flow of oxygen gas through the outer tube oxy-hydrogen flame. The delivered oxygen gas is supplied in excess to the stoichiometric amount to completely burn the delivered hydrogen gas. This excess of oxygen gas is used to partially oxidize the hydrocarbon gas that directly contacts the oxy-hydrogen flame. The conversion of a hydrocarbon gas to syngas through partial oxidation proceeds without an external heat supply. A required high-temperature within the reactor is a parameter for optimization to generate maximum syngas and it can easily be achieved by adjusting hydrogen and oxygen flows. The oxygen provided can be of an industrial grade oxygen, for example, from 90% to 99.9% of O₂ in contrast to air, which contains about 21% of oxygen. The stoichiometry of a partial oxidation reaction is as follows:

CnHm+n/2O₂=nCO+m/2H₂ (1)

However, if oxygen is provided in a sub-stoichiometric (in respect to full combustion) amount another chemical path which decreases the syngas production, and promotes carbon particles and tar formation in the gas may occur, as follows:

CnHm+n/2O₂=n/4CO₂+n/2H₂O+C_{n-n/4}Hₘ₋ₙ(coke, soot, tar) (2)

Thus, reaction 1 is the desired one during operation of the reactor, while reaction 2 generates unwanted products.

As described in the literature (Fuel 92 (2012) 369-372; Proceedings of 19th European Biomass Conference and Exhibition pp. 1530-1538. 6-10 Jun. 2011, Berlin, Germany. DOI:10.571/19thEUBCE2011-VP2.4.1) an interaction of an oxy-hydrogen flame with a hydrocarbon gas aids to avoid reaction 2 and promote reaction 1. The oxy-hydrogen flame, provided by the reactor described herein, due to its high temperature (about 2800° C.) consists of water vapor molecules and reactive radicals. “OH—” radicals are especially active in decompositions of hydrocarbons. Simply, partial oxidation 1 may proceed through steam reforming without a solid catalyst as follows

CnHm+nH₂O=nCO+(m/2+n)H₂ (3)

nH₂+n/2O₂=n H₂O (4)

A stoichiometric summation of consecutive reactions 3 and 4 gives reaction 1. A maximum syngas production efficiency may not be achieved at a minimum sub-stoichiometric (compared to full combustion) hydrocarbon-oxygen ratio as shown by reaction 1. Typically, some amount of hydrocarbon gas is fully oxidized (combusted) in the process to reach temperatures allowing the remaining hydrocarbon gas to be converted into syngas.

As such, the use of the reactor discloses herein corresponds to a non-catalytic method of activation and promotion of reaction 1. The reactor and method disclosed herein robustly produces syngas from a variety of hydrocarbon gases, which can include inorganic and organic contaminants such as H₂S, NH₃, COS, mercaptans. This is on the contrary to catalytic methods where those contaminates poison the catalyst decreasing the syngas production rate to a unacceptable level.

With reference to FIGS. 1 and 2. A reactor 100 is provided. The reactor 100 has a multi-tubular oxy-hydrogen burner 102 having a first end and a second end. The first end of the multi-tubular oxy-hydrogen burner 102 extends along a longitudinal axis 104 from a first reactor wall 106. The oxy-hydrogen multi-tubular burner 102 has an outer surface 108. The oxy-hydrogen multi-tubular burner 102 can have of an inner tube 126 and an outer tube 128 surrounding the inner tube 126. The oxy-hydrogen multi-tubular burner 102 can comprise of more than two tubes, such as, for example, three tubes, four tubes, or five tubes.

An oxy-hydrogen flame is generated at the second end of the multi-tubular oxy-hydrogen burner 102 by an ignition of a flow of hydrogen gas delivered through the inner tube and a flow of oxygen gas delivered through the outer tube of the multi-tubular oxy-hydrogen burner 102. The flow hydrogen gas and oxygen can be controlled and adjusted to a specific hydrocarbon gas, such the soot formation and an efficient performance of the reactor and method is obtained.

The reactor 100 also comprises a tube 130 made of a high temperature resistant material 110 having a first end and a second end extending along the longitudinal axis 104. The high temperature resistant material 110 can comprise quartz, ceramic, alumina, or mullite, or a combination thereof. For example, the high temperature resistant material 110 can comprise transparent quartz. The tube made of a high temperature resistant material 110 can have any shape, such as, for example, cylindrical, square, rectangular, triangular, or hexagonal. In one example, the tubes made of a high temperature resistant material 110 can have a cylindrical shape.

The tube of the high temperature resistant material 110 has an inner surface 112. The tube of the high temperature resistant material 110 surrounds the multi-tubular oxy-hydrogen burner 102. A space is defined between the outer surface 108 of the multi-tubular oxy-hydrogen burner 102 and the inner surface 112 of the tube of the high temperature resistant material 110. This space allows for a flow of hydrocarbon gas to be introduced substantially parallel to the oxy-hydrogen flame such that it directly contacts the oxy-hydrogen flame generated by the multi-tubular oxy-hydrogen burner 102. The partial oxidation process of the hydrocarbon process initiates when the hydrocarbon gas contacts the oxy-hydrogen flame. The temperature of the oxy-hydrogen flame in its core can be as high as 2,800° C.

A space is also defined between the first end of the tube of the high temperature resistant material 110 and the first reactor wall 106. This space allows for the hydrocarbon gas to enter the space described above that is defined between the outer surface 108 of the multi-tubular oxy-hydrogen burner 102 and the inner surface 112 of the tube of the high temperature resistant material 110.

The tube of the high temperature resistant material 110 extends past the second end of the multi-tubular oxy-hydrogen burner 102 along the longitudinal axis 104. A partial oxidation zone 114 is formed from the second end of the multi-tubular oxy-hydrogen burner 102 to the second end of the tube of the high temperature resistant material 110. The hydrocarbon gas contacts the oxy-hydrogen flame in the partial oxidation zone 114 to partially oxidize the hydrocarbon gas to form syngas.

The H₂/CO molar ratio in the produced syngas can be controlled by adjusting the ratios between hydrocarbon, oxygen and hydrogen. That is, the reactor and the method disclosed herein can be operated to produce syngas of a desired composition.

In one aspect, the method further comprises adjusting the flow of the hydrogen gas and the oxygen gas to maintain a stable flame plume and to suppress soot formation in continuous operation. That is, the flow of the hydrogen gas and the oxygen gas can be adjusted to minimize their consumption per the syngas produced

In one aspect, the superficial velocity of the flow of the hydrogen can be from about 100 ft/s to about 400 ft/s. For example, the superficial velocity of the flow of the hydrogen can be from about 200 ft/s to about 400 ft/s. In another example, the superficial velocity of the flow of the hydrogen can be from about 300 ft/s to about 400 ft/s. In yet another example, the superficial velocity of the flow of the hydrogen can be from about 200 ft/s to about 300 ft/s. In yet another example, the superficial velocity of the flow of the hydrogen can be from about 100 ft/s to about 300 ft/s.

In one aspect, the superficial velocity of the flow of the oxygen can be from about 10 ft/s to about 50 ft/s. For example, the superficial velocity of the flow of the oxygen can be from about 20 ft/s to about 50 ft/s. In another example, the superficial velocity of the flow of the oxygen can be from about 20 ft/s to about 40 ft/s. In yet another example, the superficial velocity of the flow of the oxygen can be from about 10 ft/s to about 30 ft/s.

In one aspect, the superficial velocity of the flow of the hydrocarbon gas can be from about 0.1 ft/s to about 0.5 ft/s. For example, the superficial velocity of the flow of the hydrocarbon gas can be from about 0.2 ft/s to about 0.5 ft/s. In another example, the superficial velocity of the flow of the hydrocarbon gas can be from about 0.2 ft/s to about 0.4 ft/s. In yet another example, the superficial velocity of the flow of the hydrocarbon gas can be from about 0.1 ft/s to about 0.3 ft/s.

The formed syngas can exit the reactor 100 from a syngas outlet 116 that can be present in a second reactor wall 118 opposing the first reactor wall 106. The syngas can in turn be collected, purified, and further processed to form chemical products such as paraffins and olefins.

The reactor 100 can further comprises a post-partial oxidation zone 120 that is located along the longitudinal axis 104 after the second end of tube of the high temperature resistant material 110. The post-partial oxidation zone 120 can comprise a catalyst 124, which can convert any unreacted hydrocarbon gas from the partial oxidation zone 114 into syngas. The unreacted hydrocarbon can be reacted with steam and/or carbon dioxide in presence of a catalyst 124 to produce syngas. A catalyst 124 can for example be used when the hydrocarbon gas is free from contaminates that can poison the catalyst 124 such as Nickel based catalyst on different oxide substrates (Al₂O₃, CeO₂, La₂O₃, MgO, and ZrO₂). Catalysts 124 for such a conversion are known in the art.

In one aspect, the method disclosed herein is performed in a reaction space that is less than 2 feet in length. For example, the length of the partial oxidation zone 114 can be less than 2 feet. In another example, the combined length of the partial oxidation zone 114 and the post-partial oxidation zone 120 can be less than 2 feet.

The method disclosed herein can be performed under negative pressure. For example, the method disclosed herein can be performed from about 12 psia to about 140 psia and higher.

The reactor 100 can further comprise at least one hydrocarbon gas inlet 122 that is in fluid communication with the space defined between the first end of the tube of the high temperature resistant material 110 and the first reactor wall 106. In one example, the reactor 100 can comprise at least two hydrocarbon gas inlets 122 that are both in fluid communication with the space defined between the first end of the tube of the high temperature resistant material 110 and the first reactor wall 106. The hydrocarbon gas inlet 122 allows hydrocarbon gas to enter the reactor 100 to be partially oxidized by the oxy-hydrogen flame. The hydrocarbon gas flows from the hydrocarbon gas inlet(s) 122 to the oxy-hydrogen flame via the space defined between the first end of the tube of the high temperature resistant material 110 and the first reactor wall 106, and also via the space defined between the outer surface 108 of the multi-tubular oxy-hydrogen burner 102 and the inner surface 112 of the tube of the high temperature resistant material 110, which space allows for the flow of the hydrocarbon gas to be introduced substantially perpendicularly to the oxy-hydrogen flame and directly contact the oxy-hydrogen flame generated by the multi-tubular oxy-hydrogen burner 102.

The hydrocarbon gas can be generated from a number of sources including, but not limited to, biomass, plastics, coal, municipal waste, natural gas, or any combination thereof. In one example, the hydrocarbon gas can be generated from natural gas. In another example, the hydrocarbon gas can be generated from biomass. In yet another example, the hydrocarbon gas can be generated from municipal waste. As such, the hydrocarbon gas can contain contaminates such as nitrogen and sulfur containing species. As described herein, such contaminates do not significantly impact the performance of the reactor or the method, because no catalyst is needed for the conversion of the hydrocarbon gas to syngas. Thus, in one aspect, the method disclosed herein is performed without a catalyst.

In one aspect, an outer surface of the tube of the high temperature resistant material 110 is attached to an inner surface of a reactor tube 130 extending along the longitudinal axis 104. The reactor tube 130 can be made of a temperature resistant material, such as, for example, ceramics.

The components of the reactor 100 described herein can be present within or as a part of a housing 132. The housing 132 can be made of steel or a suitable metal.

### 2. Aspects

In view of the disclosure herein below are described certain more particularly described aspects of the inventions. These particularly recited aspects should not however be interpreted to have any limiting effect on any different claims containing different or more general teachings described herein, or that the “particular” aspects are somehow limited in some way other than the inherent meanings of the language and formulas literally used therein.

Aspect 1: A method of producing syngas comprising the steps of: a) providing an oxy-hydrogen flame generated by a multi-tubular oxy-hydrogen burner comprising an inner tube and an outer tube by delivering a flow of hydrogen gas through the inner tube and delivering a flow of oxygen gas through the outer tube of the multi-tubular oxy-hydrogen burner, wherein the delivered oxygen gas is provided in excess to the stoichiometric amount to completely burn the delivered hydrogen gas; and b) directly interacting hydrocarbon gas with the oxy-hydrogen flame by introducing the hydrocarbon gas upstream of the multi-tubular oxy-hydrogen burner to flow in a direction substantially parallel to the oxy-hydrogen flame, wherein the excess of the oxygen gas in the oxy-hydrogen flame partially oxidizes the hydrocarbon gas to produce syngas.

Aspect 2: The method of aspect 1, wherein the method further comprises adjusting the flow of the hydrogen gas and the oxygen gas to minimize their consumption per the syngas produced.

Aspect 3: The method of aspects 1 or 2, wherein the method further comprises adjusting the flow of the hydrogen gas and the oxygen gas to obtain a desired ratio of hydrogen:carbon monoxide in the produced syngas.

Aspect 4: The method of anyone of aspects 1-3, wherein the method further comprises adjusting the flow of the hydrogen gas and the oxygen gas to maintain a stable flame plume and to suppress soot formation in continuous operation.

Aspect 5: The method of anyone of aspects 1-4, wherein the superficial velocity of the flow of the hydrogen is from about 100 ft/s to about 400 ft/s.

Aspect 6: The method of anyone of aspects 1-5, wherein the superficial velocity of the flow of the oxygen is from about 10 ft/s to about 50 ft/s.

Aspect 7: The method of anyone of aspects 1-6, wherein the superficial velocity of the flow of the hydrocarbon gas is from about 0.1 ft/s to about 0.5 ft/s.

Aspect 8: The method of anyone of aspects 1-7, wherein the method is performed without the use of a catalyst.

Aspect 9: The method of anyone of aspects 1-8, wherein the method is performed in a reaction space that is less than 2 feet in length.

Aspect 10: The method of anyone of aspects 1-9, wherein method further comprises contacting unreacted hydrocarbon gas with steam and/or carbon dioxide in presence of a catalyst to produce syngas.

Aspect 11: The method of anyone of aspects 1-10, wherein the method is performed under negative pressure.

Aspect 12: The method of anyone of aspects 1-11, wherein the method is performed in the reactor of anyone of aspects 13-20.

Aspect 13: A reactor comprising: a) a multi-tubular oxy-hydrogen burner having a first end and a second end, wherein the first end extends along a longitudinal axis from a first reactor wall, wherein the oxy-hydrogen multi-tubular burner has an outer surface; and b) a tube made of a high temperature resistant material having a first end and a second end extending along the longitudinal axis, wherein the tube of the high temperature resistant material has an inner surface, i) wherein a space is defined between the first end of the tube of the high temperature resistant material and the first reactor wall, ii) wherein the tube of the high temperature resistant material surrounds the multi-tubular oxy-hydrogen burner, thereby defining a space between the outer surface of the multi-tubular oxy-hydrogen burner and the inner surface of the tube of the high temperature resistant material, iii) wherein the tube of the high temperature resistant material extends past the second end of the multi-tubular oxy-hydrogen burner along the longitudinal axis, and iv) wherein a partial oxidation zone is formed from the second end of the multi-tubular oxy-hydrogen burner to the second end of the tube of the high temperature resistant material.

Aspect 14: The reactor of aspect 13, wherein the reactor further comprises a syngas outlet in a second reactor wall opposing the first reactor wall.

Aspect 15: The reactor of aspects 13 or 14, wherein the reactor further comprises a post-partial oxidation zone that is located along the longitudinal axis after the second end of tube of the high temperature resistant material.

Aspect 16: The reactor of anyone of aspects 13-15, wherein the reactor further comprises at least one hydrocarbon gas inlet that is in fluid communication with the space defined between the first end of the tube of the high temperature resistant material and the first reactor wall.

Aspect 17: The reactor of aspects 15 or 16, wherein the post-partial oxidation zone comprises a catalyst.

Aspect 18: The reactor of anyone of aspects 13-17, wherein the high temperature resistant material comprises quartz or ceramic, or a combination thereof.

Aspect 19: The reactor of anyone of aspects 13-18, wherein the multi-tubular oxy-hydrogen burner consists of an inner tube and an outer tube surrounding the inner tube.

Aspect 20: The reactor of anyone of aspects 13-19, wherein an outer surface of the tube of the high temperature resistant material is attached to an inner surface of a reactor tube extending along the longitudinal axis.

### 3. Examples

The following examples are put forth so as to provide those of ordinary skill in the art with a complete disclosure and description of how the compounds, compositions, articles, devices, and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

An industrial catalytic method to convert methane, which is the primary component of natural gas, into syngas (a mix of H₂ and CO in presence of CO₂, H₂O (steam), and hydrocarbons) in methane-steam reforming furnaces is typically represented by two reactions, as follows:

CH₄+H₂O=CO+3H₂−206 kJ (endothermic) (5)

CO+H₂O=CO₂+H₂+41 kJ (exothermic) (6)

This process requires the use of a catalyst, an excess of steam (a regular methane:steam volumetric ratio is 1:3-4), and an external heat supply at a high temperature (around 900° C.). A significant portion of methane is combusted to heat up tubes with a catalyst where another methane stream is converted into syngas. A methane steam reforming furnace scales down very poorly resulting in an inappropriate increase in capital cost per unit of the syngas produced. An application of this technology to other hydrocarbons is rather impossible without a usage of suitable catalysts which are very sensitive to a presence of impurities such as sulfur, nitrogen, chlorine containing species.

This examples compares the method and reactor disclose herein with the industrial catalytic process described above.

The method disclosed herein was executed using the reactor disclosed herein, and its performance was compared with an industrial catalytic methane conversion process (reactions 5 and 6) in a methane-steam reforming furnaces with a regular conversion rate of 90%. The thermodynamic parameters and superficial velocities of the input flows in regards to method and reactor described herein are listed in Table 1.

TABLE 1

| | |
|---|---|
| Input temperature, ° C. (for all flows) | 20-25 |
| Operational pressure, psia | 12-13 |
| Superficial velocities in the burner tubes | |
| H₂, ft/s | 100-400 |
| O₂,ft/s | 10-50 |
| Superficial velocity of CH₄ into reaction space, ft/s | 0.1-0.5 |
| Length of the reaction space | Less than 2 ft |

Two input ratios between oxygen and hydrogen and methane (O_{2_}in/CH4_in and H2_in/CH4_in) shown in Tables 2-5 together with parameters of Table 1 define the operating conditions of the example. The following efficiency indicators are chosen for a comparison: methane conversion efficiency into CO and CO₂ as a ratio between output and input volumetric flows at standard conditions [CO+CO₂]/CH_{4_}in; total methane conversion efficiency into syngas [H₂+CO]/CH_{4_}in, and net methane conversion efficiency into syngas [H₂+CO—H_{2_}in]/CH_{4_}in where H_{2_}in is hydrogen consumed in the burner. The stoichiometry of methane partial oxidation is as follows:

CH₄+0.5O₂=CO+2H₂ (7)

As seen in Table 2, in order to reach a 90% conversion rate into CO and CO₂ oxygen consumption exceeds the stoichiometric ratio (0.5 vs. 1.1 in Table 2). As mentioned before to convert 66% of methane through reactions (5) and (6), 33% of it is combusted with air in the furnace to provide heat for endothermic reaction (5). Taking into account a typical 90% conversion rate of methane in the furnace and stoichiometry of reaction (5), a methane conversion efficiency into syngas [H2+CO]/CH4_in as 4*0.9/1.5=2.4 was obtained. Both efficiencies 1.7 (total) and 1.4 (net) are lower than 2.4 for the industrial process. However, for methane conversion to CO+CO₂, the value 0.91 in Table 2 is higher than 0.9/1.5=0.6 for the industrial process (CO₂ obtained as a result of methane combustion in the furnace is lost for the following chemical processing). Thus, the method disclosed herein favors production of carbon monoxide meaning that at a substantial excess of H2 over CO2 (see syngas composition in Table 2) the latter can be converted to CO by an industrially employed water-gas shift reaction, as follows:

CO2+H2=CO+H2O (vapor) (8)

Carbon monoxide (CO) is a poisonous gas but widely utilized in chemical manufacturing of plastics (more than 1 million tons per year).

TABLE 2

| Input parameters | | | Output parameters | |
|---|---|---|---|---|
| (volumetric ratios) | | | (efficiency indicators) | |
| O₂_in/ | H₂_in/ | [CO + CO₂]/ | [H₂ + CO]/ | [H₂ + CO − H₂_in]/ |
| CH₄_in | CH₄_in | CH₄_in | CH₄_in | CH₄_in |
| 1.1 | 0.27 | 0.91 | 1.7 | 1.4 |

Output parameters ( syngas composition), % vol.

| H₂ | CH₄ | CO | CO₂ | C₂H₂ |
|---|---|---|---|---|
| 47.05 | 2.97 | 31.42 | 11.22 | 0.58 |

Table 3 lists values for the disclosed method when the flow of hydrogen into the burner is turned off after an origination of the methane flame plume. As seen in Table 3, the total amount of syngas decreased (1.5 vs. 1.7) demonstrating that the oxy-hydrogen flame, indeed, promotes syngas formation, however, the net syngas value is higher (1.5 vs. 1.4) when hydrogen flow is zero. Accounting for this, the hydrogen flow into the burner is used to start methane partial oxidation and, then, might be minimized just to sustain the flame.

TABLE 3

| Input parameters | | | | |
|---|---|---|---|---|
| (volumetric ratios) | | Output parameters (efficiency indicators) | | |
| O₂_in/ | H₂_in/ | [CO + CO₂]/ | [H₂ + CO]/ | [H₂ + CO − H₂_in]/ |
| CH₄_in | CH₄_in | CH₄_in | CH₄_in | CH₄_in |
| 1.1 | 0 | 0.93 | 1.5 | 1.5 |

Output parameters ( syngas composition)

| H₂ | CH₄ | CO | CO₂ | C₂H₂ |
|---|---|---|---|---|
| 43.84 | 2.56 | 32.27 | 13.93 | 0.45 |

A certain decrease in oxygen/methane ratio from 1.1 in Table 2 to 1.0 in Table 4 leads to a decrease in methane conversion rate [CO+CO2]/CH_{4_}in but syngas production rate stays almost the same. This indicates that with an increase in oxygen flow (from Table 4 to Table 2) syngas generation is offset by its combustion. This fact is reflected in the syngas composition by a decrease in the CO/CO₂ ratio from 3.2 in Table 4 (lower oxygen flow) to 2.8 in Table 2 (higher oxygen flow).

TABLE 4

| Input parameters | | | | |
|---|---|---|---|---|
| (volumetric ratios) | | Output parameters (efficiency indicators) | | |
| O₂_in/ | H₂_in/ | [CO + CO₂]/ | [H₂ + CO]/ | [H₂ + CO − H₂_in]/ |
| CH₄_in | CH₄_in | CH₄_in | CH₄_in | CH₄_in |
| 1.0 | 0.27 | 0.83 | 1.7 | 1.4 |

Output parameters ( syngas composition)

| H₂ | CH₄ | CO | CO₂ | C₂H₂ |
|---|---|---|---|---|
| 47.90 | 5.77 | 29.40 | 9.14 | 1.04 |

FIG. 3 demonstrates how total syngas production and methane conversion efficiencies respond on an increase in O₂ flow and respective decrease in H₂/O₂ ratio. With an increase in oxygen flow into the burner a rise in syngas production is diminishing. A utilization of a catalytic block to proceed through steam or dry reforming of methane (reactions (5), (6)) at higher degrees of methane conversion (higher than 0.8 in FIG. 3) is very complimentary to the non-catalytic partial oxidation promoted by the oxy-hydrogen flame. At this point, volumetric H₂O(steam)+CO₂ ratio to the rest of methane exceeds five and, therefore, provides a great opportunity for an auto-thermal catalytic reforming.

At decreasing oxygen and increasing hydrogen flows (Table 5), methane conversion decreases to [CO+CO₂]/CH_{4_}in=0.64 but converted methane is mostly utilized toward syngas generation. Therefore, syngas production efficiency 1.6 in Table 5 closely corresponds to its stoichiometric value 0.64*3=1.92 as per partial oxidation reaction (7). This fact confirms that the phenomenological mechanism of the oxy-hydrogen flame interaction with a hydrocarbon gas to carry out reaction (7) might be explained by a combination of reactions (3) and (4).

TABLE 5

| Input parameters | | | | |
|---|---|---|---|---|
| (volumetric ratios) | | Output parameters (efficiency indicators) | | |
| O₂_in/ | H₂_in/ | [CO + CO₂]/ | [H₂ + CO]/ | [H₂ + CO − H₂_in]/ |
| CH₄_in | CH₄_in | CH₄_in | CH₄_in | CH₄_in |
| 0.84 | 0.53 | 0.64 | 1.6 | 1.1 |

Output parameters ( syngas composition)

| H₂ | CH₄ | CO | CO₂ | C₂H₂ |
|---|---|---|---|---|
| 50.12 | 13.20 | 22.98 | 5.52 | 1.59 |

An increasing ratio H₂/O₂ in the burner and approaching the partial oxidation stoichiometry of reactions (5) and (7) leads to a decrease in net-syngas production and methane conversion rates.

A careful investigation of surfaces within the reactor and of the reaction space after reactor disassembling showed no traces of soot or carbon particles.

What is claimed is:

1. A method of producing syngas comprising the steps of:
a) providing an oxy-hydrogen flame generated by a multi-tubular oxy-hydrogen burner comprising an inner tube and an outer tube by delivering a flow of hydrogen gas through the inner tube and delivering a flow of oxygen gas through the outer tube of the multi-tubular oxy-hydrogen burner, wherein the delivered oxygen gas is provided in excess to the stoichiometric amount to completely burn the delivered hydrogen gas; and
b) directly interacting hydrocarbon gas with the oxy-hydrogen flame by introducing the hydrocarbon gas upstream of the multi-tubular oxy-hydrogen burner to flow in a direction substantially parallel to the oxy-hydrogen flame, wherein the excess of the oxygen gas in the oxy-hydrogen flame partially oxidizes the hydrocarbon gas to produce syngas.

2. The method of claim 1, wherein the method further comprises adjusting the flow of the hydrogen gas and the oxygen gas to minimize their consumption per the syngas produced.

3. The method of claim 1, wherein the method further comprises adjusting the flow of the hydrogen gas and the oxygen gas to obtain a desired ratio of hydrogen gas:carbon monoxide in the produced syngas.

4. The method of claim 1, wherein the method further comprises adjusting the flow of the hydrogen gas and the oxygen gas to maintain a stable flame plume and to suppress soot formation in continuous operation.

5. The method of claim 1, wherein the superficial velocity of the flow of the hydrogen is from about 100 ft/s to about 400 ft/s.

6. The method of claim 1, wherein the superficial velocity of the flow of the oxygen is from about 10 ft/s to about 50 ft/s.

7. The method of claim 1, wherein the superficial velocity of the flow of the hydrocarbon gas is from about 0.1 ft/s to about 0.5 ft/s.

8. The method of claim 1, wherein the method is performed without the use of a catalyst.

9. The method of claim 1, wherein the method is performed in a reaction space that is less than 2 feet in length.

10. The method of claim 1, wherein method further comprises contacting unreacted hydrocarbon gas with steam and/or carbon dioxide in presence of a catalyst to produce syngas.

11. The method of claim 1, wherein the method is performed under negative pressure.

12. The method of claim 1, wherein the method is performed in the reactor of claim 13.

13. A reactor comprising:
a) a multi-tubular oxy-hydrogen burner having a first end and a second end, wherein the first end extends along a longitudinal axis from a first reactor wall, wherein the oxy-hydrogen multi-tubular burner has an outer surface; and
b) a tube made of a high temperature resistant material having a first end and a second end extending along the longitudinal axis, wherein the tube of the high temperature resistant material has an inner surface,
i) wherein a space is defined between the first end of the tube of the high temperature resistant material and the first reactor wall,
ii) wherein the tube of the high temperature resistant material surrounds the multi-tubular oxy-hydrogen burner, thereby defining a space between the outer surface of the multi-tubular oxy-hydrogen burner and the inner surface of the tube of the high temperature resistant material,
iii) wherein the tube of the high temperature resistant material extends past the second end of the multi-tubular oxy-hydrogen burner along the longitudinal axis, and
iv) wherein a partial oxidation zone is formed from the second end of the multi-tubular oxy-hydrogen burner to the second end of the tube of the high temperature resistant material.

14. The reactor of claim 13, wherein the reactor further comprises a syngas outlet in a second reactor wall opposing the first reactor wall.

15. The reactor of claim 13, wherein the reactor further comprises a post-partial oxidation zone that is located along the longitudinal axis after the second end of tube of the high temperature resistant material.

16. The reactor of claim 13, wherein the reactor further comprises at least one hydrocarbon gas inlet that is in fluid communication with the space defined between the first end of the tube of the high temperature resistant material and the first reactor wall.

17. The reactor of claim 15, wherein the post-partial oxidation zone comprises a catalyst.

18. The reactor of claim 13, wherein the high temperature resistant material comprises quartz or ceramic, or a combination thereof.

19. The reactor of claim 13, wherein the multi-tubular oxy-hydrogen burner consists of an inner tube and an outer tube surrounding the inner tube.

20. The reactor of claim 13, wherein an outer surface of the tube of the high temperature resistant material is attached to an inner surface of a reactor tube extending along the longitudinal axis.
